(19) United States
(12) Patent Application Publication
(10) Pub. No.: US 2022/0258453 A1
(43) Pub. Date: Aug. 18, 2022

(54) THERMAL SHIELDING DEVICE, MATERIALS, AND METHODS THEREOF

(71) Applicants: Productive Research LLC, West Bloomfield, MI (US); Material Sciences Corporation, Canton, MI (US)

(72) Inventors: Bryan Joseph Tullis, Commerce Twp, MI (US); Shimon Mizrahi, Haifa (IL); Eyal Mizrahi, West Bloomfield, MI (US)

(21) Appl. No.: 17/628,346

(22) PCT Filed: Jul. 20, 2020
(86) PCT No.: PCT/US2020/042736

§ 371 Date: Jan. 19, 2022

Related U.S. Application Data
(60) Provisional application No. 62/876,096, filed on Jul. 19, 2019.

(51) Int. Cl. B32B 15/08; B32B 7/06; B32B 27/20; B32B 3/04; B32B 3/26; B32B 3/08; H01M 50/249

(52) U.S. Cl. CPC B32B 15/08; H01M 2220/20; B32B 27/20; B32B 3/04; B32B 3/263; B32B 3/08; H01M 50/249; B32B 2307/302; B32B 2307/72; B32B 2307/732; B32B 2307/3065; B32B 2264/108; B32B 2307/212; B32B 2457/10; B32B 2250/03; B32B 2250/40; B32B 2307/102; B32B 2307/304; B32B 7/06

(57) ABSTRACT

The teachings herein relate to thermal shielding devices for reducing and/or delaying heating of a region near a heat source. The thermal shielding device is preferably formed of a composite material. The composite material preferably has a core layer that is generally thermally insulating.

### FIELD

The teachings herein are directed to thermal shielding devices for reducing the flow of thermal energy. The thermal shielding device is formed of a composite material and includes a two metal layers separated by a core layer. The reduction in the flow of thermal energy may include a reduction in thermal conductivity, increase in separation between the metal layers following an extreme thermal event, absorption of energy via an endothermic reaction, or any combination thereof.

### BACKGROUND

Heat shields typically are made from sheets of metal with the sole purpose of providing a direct barrier for the propagation of a flame from one side of the heat shield to the other side of the heat shield. However, in some applications, there is also a need to also reduce the flow of heat from one side of the heat shield to the other side of the shield. As the heat shields are typically made of metals having high thermal conductivity, heat quickly flows from one side to another. This may be problematic particularly where there is minimal space on the “cool” side between the heat shield and objects which needs to be protected. An example is in a vehicle powered by battery cells, where there is limited spacing between the battery cells and a passenger compartment.

As vehicle batteries increase in capacity and/or size, the weight of heat shield generally increases. This weight can affect the vehicle performance, particularly with respect to energy efficiency.

There is a need for thermal shielding devices having one or any combination of the following features: reduced flow of heat through the device, reduced thermal conductivity of the device, reduced weight, ability to expand in thickness more than from thermal expansion coefficient, ability to absorb thermal energy due to an endothermic reaction, ability to retard a flame, or ability to reduce sound transmission.

### SUMMARY

One or more of the above needs are solved with the thermal shielding devices, methods, systems, and battery covers according to the teachings herein.

One aspect of the teachings herein is directed at a thermal shielding device (i.e., heat shield device) comprising: a first metal layer; a second metal layer; and a polymeric core layer interposed between the first metal layer and the second metal layer, wherein the thermal shielding device has a thermal conductivity of about 0.05 to about 4 W/mK, and the polymeric core layer generates or releases a sufficient amount of gas at a temperature of about 100° C. or more so that a separation between the first and second metal layers increases in one or more regions and a thickness of the thermal shielding device increases by about 15 percent or more.

Another aspect of the teachings herein is directed at a thermal shielding device comprising: a first metal layer; a second metal layer; and a polymeric core layer interposed between the first metal layer and the second metal layer, wherein the thermal shielding device has a thermal conductivity of about 0.05 to about 4 W/mK, and upon heating (preferably to a temperature of about 100° C. or more), the polymeric core layer causes a separation distance between the first and second metal layers to increase in one or more regions and a thickness of the thermal shielding device to increase by about 15 percent or more in the one or more regions.

Another aspect of the teachings herein is directed at a battery cover for an electric vehicle including a thermal shielding device.

Another aspect of the teachings herein is directed at a system including a battery for an electric vehicle and a thermal shielding device for shielding a compartment or component.

These aspects may be further characterized by one or any combination of the following features: the polymeric core layer generates or releases a sufficient amount of gas at a temperature of about 100° C. or more to cause the separation of the metal layers and the increase in the thickness of the thermal shielding device in the one or more regions; the polymeric core layer includes a compound having one or more waters of hydration; the polymeric core layer includes a flame retardant; the polymeric core layer has a density of about 0.90 to about 2.00 g/cm³ at a temperature of about 25° C.; the polymeric core layer is formed of a material, excluding any voids and/or pores in the polymeric core layer, having a density of about 0.90 to about 2.00 g/cm³ at a temperature of about 25° C.; the polymeric core layer includes a polymer, and the thermal shielding device includes a catalyst that accelerates a degradation of the polymer (preferably so that the pressure between the metal layers is increased); the thermal shielding device has a thickness of about 0.70 mm to about 5.0 mm, and wherein a ratio of a thickness of the polymeric core layer to the thickness of the thermal shielding device is about 0.25 to about 0.80; the polymeric core layer melts and expands at a temperature of about 100° C. or more; the melting and expansion of the polymeric core layer increases a separation distance between the first and second metal layers; the polymeric core layer includes a gas generating or releasing compound (e.g., a chemical blowing agent, a hydrate, a desiccant material, a flame retardant, or other compound) that activates at a temperature of about Tm+30° C. or more, where Tm is a peak melting temperature of the polymeric core layer, as measured according to differential scanning calorimetry; the polymeric core layer includes a flame retardant compound; the flame retardant compound includes a compound that produces or releases water a temperature of about Tm+30° C. or more, where Tm is a peak melting temperature of the polymeric core layer, as measured according to differential scanning calorimetry; the flame retardant compound includes a halogenated compound (preferably including bromine); the flame retardant compound includes phosphorous or graphene; the polymeric core layer includes a reinforcing filler (preferably a mineral filler); the polymeric core layer has a thickness of about 0.40 mm or more, (e.g., about 0.60 mm or more, about 0.80 mm or more, or 1.00 mm or more); the thermal shielding device has an area of about 0.05 m² or more and/or about 20.0 m² or less; an amount of any metal particles (e.g., metal fibers or other metal particles) in the polymeric core layer is sufficiently low so that the thermal conductivity of the polymeric core layer is about 2.0 W/mK or less (preferably about 1.00 W/mK or less, and more preferably about 0.80 W/mK); the amount of the metal particles is about 10.0 volume percent or less, about 6.00 volume percent or less, about 3.0 volume percent or less, or about 2.0 volume percent or less, based on the volume of the polymeric core layer; the device provides EMI shielding properties; the polymeric core layer includes a first polymer having a melting temperature of about 100° C. to about 225° C. for providing a separation between the first and second metal layers upon melting of the first polymer; the polymeric core layer includes multiple layers including a mid-layer interposed between two additional layers, wherein the mid layer comprises the first polymer, and the two additional layers include one or more second polymers that are cross-linked and/or have a melting temperature greater than the melting temperature of the first polymer; melting of the polymeric core layer initially occurs towards a center of the polymeric core layer; any attachment of the first and second metal layers (e.g., an attachment that attaches the metal layers together or attaches one or both metal layers to a component) allows a separation distance between the metal layers to increase in at least one or more regions upon melting of the polymeric core layer; the device includes a sealing component for covering an edge of the polymeric core layer, preferably wherein the sealing component is attached to only one of the metal layers (i.e., only the first metal layer, or only the second metal layer); the sealing component is formed by bending the first metal layer or the second metal layer; the sealing component is formed by bending the first metal layer over an edge of the second metal layer; the sealing component is welded to the second metal layer; at least a portion of the sealing component is interposed between the first metal layer and the second metal layer; the core polymeric layer extends to the sealing component; a void space is present between the edge of the core polymeric layer and the sealing component; the first metal layer includes a metal sheet having a length and a width and the second metal layer includes a metal sheet having the same length and width; the first metal layer includes a first metal sheet having a length and a width and the second metal layer includes a second metal sheet having a length and/or a width that is different from the first metal sheet; the device has good sound dampening properties as characterized by a composite loss factor of about 0.010 or more at a temperature of about 50° C. and a frequency of about 100 Hz; the battery cover is for a plug-in electric vehicle; the thermal shielding device, in an initial state prior to heating, includes a mechanical or physical feature (e.g., stored with potential energy that is released upon melting and/or softening of the polymer in the one or more regions; the potential energy or physical includes one or more springs in a compressed state and arranged for expanding in a direction of the thickness of the thermal shielding device; the potential energy includes one or more of the metal layers being in a compressed state, wherein the metal layer moves towards the uncompressed state upon melting and/or softening of the polymer, causing the metal layers to separate; the potential energy includes an oriented polymer and/or a compressed rubber in the core layer; one or both of the metal layers includes a wrinkle, a fold, a pleat, or other feature that allows the metal layer to expand, preferably without yielding; one or more edges of the device is covered with a folded covering component which covers the edges and unfolds when the metal layers separate; the covering component seals the metal edge of the thermal shielding device; the folded covering component is formed from one of the metal layers and/or is connected to the metal layers; the battery cover is positioned between a vehicle battery that provides power for an electric motor that drives the vehicle and a passenger compartment; the system comprising an electric motor for driving one or more wheels of a vehicle; one or more battery cells for providing power to the electric motor; the battery cover is arranged over one or more of the battery cells, the battery cover is generally horizontal; the battery cover is attached to a container that holds one or more battery cells; the battery cover is attached to a vehicle body and arranged below a passenger compartment; or the system includes a gap above or below the battery cover for allowing a separation of the first and second metal layers to increase.

### BRIEF DESCRIPTION OF THE DRAWINGS

FIG. 1 is a cross-sectional side view of a composite material, through the thickness of the composite material, according to the teachings herein that may be employed in a thermal shielding device.

FIG. 2 is a top view of a thermal shielding device showing one or more shielding regions and one or more extension regions. The extension regions may be formed of the same material as material of the shielding region or may be formed of a different material.

FIG. 3 is a top view of a thermal shielding device showing one or more attachment locations located at or near an edge region of device.

FIG. 4 is a side cross-section view of a thermal shielding device showing the layers of a composite material in a shielding region and one or more bent portions, protrusions, or extensions that are angled relative to the shielding region. A bent portion, protrusion, or extension may be made of the composite material or of a different material.

FIG. 5 is an illustrative side view cross-section showing a thermal shielding device being expanded during an extreme thermal event. As illustrated in FIG. 5, an edge of the composite material may be sealed. For example, the two metal layers may be welded, joined or otherwise sealed at their common edges.

FIG. 6 is an illustrative cross-sectional view of an edge region.

FIG. 7A is a cross-sectional view of an illustrative edge region of a thermal shielding device showing an attachment of the device.

FIG. 7B shows features of FIG. 7A after a core layer has expanded (e.g., during or after an extreme thermal event).

FIG. 8 is a cross-sectional view of an illustrative edge region having a break point.

FIG. 9 is a cross-sectional view showing local expansion of a thermal shielding device due to an extreme thermal event.

FIG. 10 is a cross-sectional view showing a composite material of a thermal shielding device having a component for storing potential energy, such as in one or more compressed springs.

FIG. 11 is a cross-sectional view showing a composite material of a thermal shielding device having a metal layer capable of expanding in one or more regions without yielding the metal layer.

FIG. 12 illustrates the exposure of the thermal shielding device of FIG. 11 to heat and the melting or softening of the polymer in a region of the core layer.

FIG. 13 illustrates the local expansion of the thermal shielding device of FIG. 12. Preferably, a separation distance between the two metal layers increases without yielding of the metal layer.

FIG. 14A is a cross-sectional view showing the formation of a composite material for a thermal shielding device using one or both metal layers that are curved.

FIG. 14B shows the composite material after forming, where the composite material includes potential energy from the metal layer(s) being in a compressed state.

FIG. 15A illustrates an edge covering component having one or more features for expanding the component without yielding a material of the covering component.

FIG. 15B illustrates the edge covering component of FIG. 15A after the core layer has expanded. Preferably the covering component seals the edge before and/or after expansion of the core layer.

### DETAILED DESCRIPTION

The thermal shielding device preferably is constructed so that the heat flow through the thermal shielding device is reduced or minimized. The thermal shielding device according to the teachings herein includes a composite material having a first metal layer and a second metal layer which are separated by a polymeric core layer. The materials of the composite material may be selected so that the thermal conductivity of the composite material in the thickness direction (i.e., going through the two metal layers and the polymeric core layer) is reduced relative to thermal conductivity of the first metal layer, the second metal layer or both.

The thermal shielding device preferably is designed so that the spacing between the metal layers may increase when the device is exposed to high temperatures, such as during an extreme thermal event as discussed herein. The separation of the metal layers may function to further reduce heat flow through the thermal shielding device.

The thermal shielding device may include one or more features that results in an endothermic reaction upon heating, so that heat transfer through the thermal shielding device is reduced.

The thermal shielding device may include one or more features that prevents or delays the polymeric core layer from burning and thus helps delay the amount of heat transferred through the device.

Although various approaches to reduce the heat transfer are discussed herein, it will be appreciated that multiple approaches may be combined to achieve further improvements.

The materials for the thermal shielding device may also be selected to achieve reduced density, particularly when the device is used in an automotive vehicle, and especially when the automotive vehicle is powered by an electric motor, such as in a plug-in electric vehicle.

Extreme Thermal Event

Extreme thermal event refers to an event that causes a temperature directly adjacent to the heat shielding device and/or on one surface of the heat shielding device to increase to a critical temperature, above a normal operating temperature. The critical temperature may be about 80° C. or more, about 120° C. or more, about 160° C. or more, about 190° C. or more, or about 210° C. or more. The critical temperature may be about 600° C. or less, about 500° C. or less, about 400° C. or less, or about 300° C. or less.

The extreme thermal event may occur due to any event or situation that causes the temperature to reach or rise above the critical temperature. Examples of such events include a fire, a battery or battery cell failure, a mechanical failure resulting in generation of frictional energy, a failure of a cooling device, and the like. The extreme thermal event may be a catastrophic event where one or more components have failed.

During an extreme thermal event, there may be a need to reduce the flow of heat in one or more directions. Reducing the flow of heat may be a needed to prevent further damage and/or to provide additional time for responding to the event.

Unless otherwise stated, the dimensions and properties of the thermal shielding device refer to the dimensions at ambient conditions (i.e., about 25° C.) prior to an extreme thermal event which may change one or more dimensions of the device.

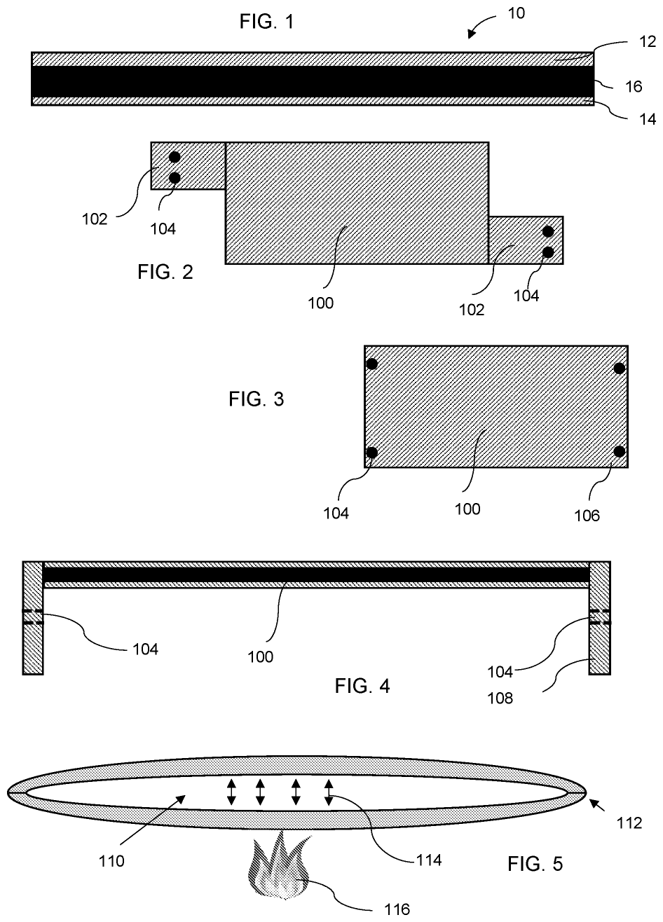

FIG. 1 is a cross-sectional side view of a portion of a thermal shielding device illustrating features of the composite material 10. The composite material 10 includes a first metal layer 12, a second metal layer 14. The composite material includes a core layer 16 interposed between the first and second metal layers. The core layer preferably is a polymeric core layer including one or more polymers. The metal layers may have the same thickness or may have different thicknesses. The metal layers may be formed of the same metal or may be formed of different metals. The metal layers may have a coating on one or more surfaces for protecting the surface and/or for improving the adhesion of the metal layer to the core layer. The metal layers may have a coating on one or more surfaces (preferably an exterior surface facing towards a heat source or battery cells) which reduces heat flow and/or heat generation. For example, the coating includes a flame retardant (preferably a polymer including a flame retardant), a nano-coating (preferably that is thermally conductive but electrically insulating), or both. Particularly preferred coating is a coating including a flame retardant. The core layer preferably is attached to the first metal layer, to the second metal layer, or both. The attachment preferably includes adhesion or bonding directly or indirectly between the core layer anFOG/d the metal layer(s). The core layer may include a polymer or an additive that improves the adhesion to one or both metal layers. One or both metal layers may be covered with an adhesive layer and/or a primer layer for providing adhesion to the core layer.

The initial thickness (e.g., at about 25° C., and prior to an extreme thermal event) of the composite material preferably is about 0.70 mm or more, more preferably about 0.90 mm or more, and most preferably about 1.20 mm or more. The initial thickness of the composite material preferably is about 6 mm or less, more preferably about 5.00 mm or less, even more preferably about 3.50 mm or less, and most preferably about 3.00 mm or less. The ratio of the initial thickness of the polymeric core layer to the initial thickness of the composite material preferably is about 0.20 or more, 0.25 or more, or about 0.30 or more and/or about 0.85 or less, about 0.80 or less, 0.75 or less, or about 070 or less. The polymeric core layer preferably has an initial thickness of about 0.40 mm or more, about 0.60 mm or more, about 0.80 mm or more, about 1.00 mm or more, or about 1.4 mm or more. The polymeric core layer preferably has an initial thickness of about 5.4 mm or less, about 4.80 mm or less, about 4.00 mm or less, about 3.00 mm or less, or about 1.90 mm or less.

The thermal shielding device preferably has a sufficient area (e.g., in a direction perpendicular or normal to the thickness direction) so that it reduces the heat exposure to one or more devices or one or more components or more compartments. The thermal shielding device preferably has an area of about 0.05 m² or more, about 0.15 m² or more, about 0.45 m² or more, or about 1.85 m² or more. In some applications, the area of the thermal shielding device is about 20.0 m² or less, about 18.0 m² or less, about 16.0 m² or less, about 13.0 m² or less or about 10 m² or less. It will be appreciated that in some applications the area of the thermal shielding device may be greater than 20.0 m². A thermal shielding device may be replaced by two or more smaller sections or components. Each section or component may include a composite material according to the teachings herein.

Thermal Conductivity

Thermal conductivity of the thermal shielding device is measured in the thickness direction, through the metal layers and the polymeric core layer. The thermal conductivity of the polymer core layer and/or the thermal shielding device preferably is about 4.0 W/mK or less, about 2.00 W/mK or less, about 1.0 W/mK or less, or about 0.80 W/mK or less. Preferably the thermal conductivity of the polymer core layer and/or the thermal shielding device is about 0.05 W/mK or more. The thermal conductivity is preferably measured at a temperature of about 25° C. Unless otherwise specified, the thermal conductivity of the thermal shielding device and/or the polymeric core layer may be measured according to ASTM D 5930 17.

Reduction in Weight/Density

The core layer and/or the metal layer may be selected to reduce the weight of the thermal shielding device.

The density of the core layer may be about 2.30 g/cm³ or less, about 2.00 g/cm³ or less, about 1.80 g/cm³ or less, about 1.60 g/cm³ or less, about 1.40 g/cm³ or less, or about 1.30 g/cm³ or less. The density of the core layer may be about 0.950 g/cm³ or more or about 1.10 g/cm³ or more.

One or both of the metal layers may be formed of a steel or may be selected to have a density less than steel. Each metal layer may independently be selected to have a density of about 8.0 g/cm³ or less, about 7.7 g/cm³ or less, about 6.8 g/cm³ or less, about 5.6 g/cm³ or less, about 5.0 g/cm³ or less, about 4.6 g/cm³ or less, about 4.1 g/cm³ or less, or about 3.3 g/cm³ or less. The density of the metal layers typically is about 2.5 g/cm³ or more. Particularly preferred metals having density less than steel include aluminum, aluminum alloys including at least 60 atomic percent aluminum atoms (based on the total number of metal atoms), titanium, and titanium alloys.

It will be appreciated that the reduction in weight and/or density may be due in part or even completely to the polymeric core layer. For example, the thickness of the core layer and/or the density of the core layer may be sufficient to result in some or all of the improvements in the weight of the thermal shielding device.

The ratio of the density of the composite material of the thermal shielding device to the average density of the metal layers preferably is about 95% or less, about 90% or less, about 85% or less, about 80% or less, or about 75% or less. The ratio of the density of the composite material of thermal shielding device to the average density of the metal layers may be about 20% or more, about 30% or more, about 40% or more, or about 50% or more. The average density of the metal layers may be calculated as D_{avg}=(t₁D₁+t₂D₂)/(t₁+t₂), where t₁ and t₂ are the thicknesses of the first and second metal layers, and D₁ and D₂ are the densities of the first and second metal layers.

Polymeric Core Layer

The polymeric core layer includes one or more polymers. The amount of polymer in the polymeric core layer should be sufficient so that the polymer forms a continuous phase and/or so that the material of the core layer can be extruded as a filled polymer. Preferably, the amount of the polymer in the polymeric core layer is about 10 weight percent or more, about 12 weight percent or more, about 14 weight percent or more, about 16 weight percent or more, about 18 weight percent or more, or about 20 weight percent or more. Although the core layer may consist entirely of the one or more polymers, the core layer preferably includes one or more non-polymeric components that help reduce heat flow, particularly during an extreme thermal event. As such, the amount of polymer in the core layer preferably is about 95 weight percent or less, about 90 weight percent or less, about 80 weight percent or less, about 70 weight percent or less, about 60 weight percent or less, about 50 weight percent or less, or about 40 weight percent or less.

Polymers

When the polymer is below its melting temperature or glass transition temperature, it may be difficult to expand when gas is released or generated in the polymeric core layer. As such, the polymer may be selected so that it is molten when gas is released or generated in the polymeric core layer (e.g., during an extreme thermal event).

Melting Temperature

As used herein, the term “melting temperature” refers to the peak melting temperature for a semi-crystalline polymer and to the glass transition temperature to a thermoplastic polymer that is amorphous. In general, the melting temperature gives an indication of the temperature at which the polymer molecules begin to flow. With respect to foaming or gas generation, this melting of the crystals or increase in free volume related to heating above the glass transition temperature results in a polymer that can more readily expand and accommodate pockets of gas.

If the melting temperature of the polymer is too low, the thermal shielding device may fail due to melting or softening of the polymer during normal use. The melting temperature preferably of the polymer preferably is about 90° C. or more, more preferably about 100° C. or more, even more preferably about 110° C. or more, and most preferably about 120° C. or more. The melting temperature of the polymer should be sufficiently low so that the polymer is above the melting temperature when the gas is being generated or released in the polymeric core layer (e.g., as a result of an extreme thermal event). The temperature of the polymer preferably is about 300° C. or less, more preferably about 240° C. or less, even more preferably about 200° C. or less, even more preferably about 170° C. or less, and most preferably about 145° C. or less. Glass transition temperature and peak melting temperature may be measured using differential scanning calorimetry at a heating rate of 10° C./min.

The polymer may melt or softens at a temperature near or below (preferably below) the activation temperature of a blowing agent. When the blowing agent activates due to thermal energy (e.g., during an extreme thermal event), the polymer foams. The polymer foam may be characterized by open cells, closed cells, or both. The pressure from the activated blowing agent and/or the foam may cause the metal layers to separate.

The polymeric core layer, prior to any extreme thermal event, may be a generally dense material. For example, the amount of any voids and/or pores in the polymeric core layer (and/or between the metal layers) may be about 15 volume percent or less, about 10.0 volume percent or less, about 5.0 volume percent or less, about 3.0 volume percent or less, or about 1.5 volume percent or less, based on the total volume of the polymeric core layer (and/or the space between the metal layers). The dense material may have about 0 volume percent or more voids and/or pores.

The polymeric core layer, prior to any extreme thermal event, may include voids and/or pores dispersed through the layer. Preferably the voids and/or pores are in the form of cells of the polymeric. As such, the polymer core layer may be foamed and/or include a foamed polymer. The amount of voids and/or pores may be sufficient so that the thermal conductivity of the thermal shielding device is reduce. Preferably, the amount of voids and/or pores in the polymeric core layer is about 3 volume percent or more, more preferably about 10 volume percent or more, even more preferably about 20 volume percent or more, and most preferably about 40 volume percent or more. The amounts of voids and/or pores in the polymeric core layer may be about 80 volume percent or less, about 70 volume percent or less, about 60 volume percent or less, or about 50 volume percent or less.

Any type of polymer may be employed in the polymeric core layer. The polymer may be a polyolefin, free of polyolefin, or a copolymer including a both an olefin and a non-olefinic monomer. The polymer may be a homopolymer or a copolymer. Examples of copolymers include random copolymers, block copolymers, graft copolymers, and alternating copolymers. Preferred polyolefin containing polymers include or consist essentially of ethylene, propylene, butene, hexene, octene, or any combination thereof. Non-polyolefin polymers include polyamides, polyimides, polyacrylates, polyesters, polyethers, polycarbonates, polyacrylonitriles, copolymers thereof, derivatives thereof, and combination thereof. The polymer may include or consist of a polystyrene. The polymer may include a polyethylene homopolymer or copolymer. Preferred polyethylene copolymers have an ethylene concentration of about 60 weight percent or more, about 70 weight percent or more, about 80 weight percent or more, about 87 weight percent or more, or about 93 weight percent or more. The polymer may include a polypropylene homopolymer or copolymer. Preferred polypropylene copolymers have a propylene concentration of about 60 weight percent or more, about 70 weight percent or more, about 80 weight percent or more, about 87 weight percent or more, or about 93 weight percent or more. Some or all of the polymer may be grafted with a functional group for improving the adhesion to a metal layer. Preferably some or all of the polymer is free of such grafts. For example, the amount of the polymer that is free of grafts may be about 70 weight percent or more, about 80 weight percent or more, about 90 weight percent or more, about 96 weight percent or more, or about 99 weight percent or more. The polymer may be a semi-crystalline polymer at 25° C. Preferred semi-crystalline polymers have a crystallinity of about 6% or more, more preferably about 10% or more, even more preferably about 20% or more, even more preferably about 30% or more, and most preferably about 38% or more. The crystallinity may be about 80% or less, about 70% or less, or about 60% or less. Crystallinity may be measured using differential scanning calorimetry at a heating rate of 10° C./min, where the heat of fusion is measured and compared with the theoretical heat of fusion known for that polymer. Crystallinity=100%×H_{f}/H_{theory}.

The polymeric core layer may include multiple polymers. The multiple polymers may be in a single layer or may be in separate layers. Multiple layers of polymer may have different melting temperatures and may be employed for locating where melting and/or expansion will initially occur. For example, it may be desirable for the initial melting to occur near the center of the polymeric core layer. Here, the polymeric core layer may include multiple layers including a mid-layer interposed between two additional layers, where the mid-layer comprises a first polymer, and the two additional layers include one or more second polymers that are cross-linked and/or have a melting temperature greater than the melting temperature of the first polymer.

Expansion

As discussed herein, one feature of the thermal shielding device may be an increase in the separation distance between the two metal layers of the device. The separation distance may be increased by a mechanical feature that is activated when the polymer in the core layer melts. The increase in the separation of the metal layers may be caused by an expansion of the core layer and/or the formation of a gas layer between two metal layers. Formation of a gas layer may be caused by one or more gas generating materials and/or one or more gas releasing materials in the polymeric core layer. The gas may be water or any other compound having a boiling point of less than about 120° C. Although the gas compound may be in a liquid phase at room temperature, it should be in gas phase at an elevated temperature, such as a temperature of the extreme temperature event.

Some or all of the gas may be i) from one or more compounds having one or more waters of hydration, ii) from a decomposition of a polymer, preferably accelerated by a catalyst, iii) from a desiccant material having water or other low boiling point compound; from a reaction of a flame retardant, or iv) from gas in an open or closed cells of a polymeric core layer (for situations where the polymeric core layer is foamed during the formation of the layer).

The melting and expansion of the polymeric core layer increases the separation distance between the first and second metal layers. The generation and/or release of gas in the polymeric core layer preferably occurs at an activation temperature Ta. The activation temperature preferably is greater than the melting temperature of the polymer by at least 30° C. (i.e, Ta≥Tm+30° C.) so that there is sufficiently large processing window for forming the polymeric core layer without activating the generation or release of the gas. More preferably, Ta≥Tm+40° C., even more preferably, Ta≥Tm+60° C., and most preferably Ta≥Tm+70° C.

Preferably, some, substantially all, or entirely all of the gas is released or generated when the polymeric core layer is heated during an extreme thermal event. For example, the amount of the gas in the polymeric core layer that is generated during the extreme thermal event may be about 10% or more, about 25% or more, about 40% or more, about 50% or more, about 60% or more, about 70% or more, about 80% or more, about 90% or more, or about 100%, based on the total amount of gas in the polymeric core layer during or following the extreme thermal event.

One or more gas molecules may be formed by the decomposition of a polymer in the polymeric core layer. As such, it may be desirable for the polymeric core layer to include a catalyst that accelerates the decomposition of the polymer. The catalyst may reduce the temperature at which the degradation of the polymer begins. The onset of degradation may be observed using thermogravimetric analysis and may be a temperature at which the mass of the polymeric core layer decreases by about 2 percent relative to the mass at a base temperature (the base temperature may be about 25° C., about 50° C., about 80° C., or about 120° C.) at a heating rate of about 10° C./min. Unless otherwise specified, the base temperature is 120° C. The onset of degradation may be measured in an air atmosphere or in an inert atmosphere. A preferred inert atmosphere is nitrogen. Unless otherwise specified, the onset of degradation is measured using an inert atmosphere of nitrogen (i.e., N₂). When employed, the catalyst preferably is used in an amount sufficient to reduce the temperature of the onset of degradation by about 20° C. or more, more preferably by about 40° C. or more, even more preferably by about 75° C. or more, and most preferably by about 100° C. or more. Any catalyst which accelerates the degradation of the polymer and the formation of gas molecules as a product may be employed. It will be appreciated that the selection of the catalyst may depend on the polymer in the polymeric core layer. Such catalysts, for example known in the field of polymer recycling, may be employed. An example of a catalyst that may be used for the degradation reaction is a zeolite catalyst. The catalyzed decomposition reaction preferably includes one or more pyrolysis reactions.

It may be desirable for the expansion of the polymeric core layer to be sufficiently low so that heat flow through the thermal shielding device is primarily via thermal conductivity. For example, heat flow via convection in the polymeric core layer may be generally prevented. Preferably the expansion of the polymeric core layer is about 1000% or less, more preferably about 750% or less, and most preferably about 500% or less so that the any heat flow via thermal convection is minimized.

It will be appreciated that different materials may generate different amounts of gas per gram of the gas releasing/gas generating material. As such, the amount of the gas releasing and/or gas generating material needed may be specified based on i) the amount of gas that is desired (e.g., in terms of moles) and/or ii) the amount of separation of the metal layers needed and/or iii) the amount of volume expansion of the polymeric core layer desired.

The amount of gas generated or released per square m² of the composite material (i.e., area measured on a face surface of a metal layer that is exposed to elevated temperature/extreme thermal event) may be about 0.01 moles/m² or more, about 0.02 moles/m² or more, about 0.05 moles/m² or more, about 0.10 moles/m² or more, or about 0.15 moles/m² or more. The amount of gas that is generated or released may be about 1.00 moles/m² or less, about 0.90 moles/m² or less, about 0.80 moles/m² or less, about 0.70 moles/m² or less, about 0.60 moles/m² or less, or about 0.50 moles/m² or less. The increase in separation of the two metal layers due do the gas preferably is about 1 mm or more, about 2 mm or more, about 5 mm or more, about 10 mm or more, about 15 mm or more, about 20 mm or more, about 25 mm or more, or about 30 mm or more.

Expansion of the thermal shielding device may be in the form of bulging of the metal layers, distancing further from each other. The bulge may have any shape. For example, the bulge may have a curved shape (e.g., on one or both metal layers), a hill shape (e.g., on one or both metal layers), an oval shape (e.g., on one or both metals), a generally flat shape (e.g., on one of the metal layers) or any combination thereof. The bulging may be localized to one or more regions of the thermal shielding device, or the bulging may be through a substantial or entire area of the thermal shielding device. As an extreme thermal event occurs, one or more regions may initially become heated and those regions may expand first. As time progresses and the thermal shielding device is further heated, the regions may expand in size and/or additional regions may expand. When the entire polymeric core layer of the thermal shielding device has become activated and released or generated gas, the maximal gap may be at or near the center of the thermal shielding device, unless the thermal shielding device is welded, bolted, or otherwise constrained in that region. Locations that are constrained, such as edge regions of the metal layers that are attached to each other or to other components may have minimal or no change in their separation. The shape of the bulging may be symmetrical or asymmetrical with respect to the two metal layers. Depending on the structure of the thermal shielding device, it may be possible to control the location of the expansion. For example, one metal layer may be relatively thin and/or be formed of a softer metal and/or have features such as pleats, wrinkles, or folds, that allow for preferred expansion of the metal layer (preferably without yielding). As another example, the two metal layers may have similar thickness, be formed of the same metal and have similar features so that the expansion is symmetric. Expansion in one direction may be limited by the presence of another component such as a housing, a frame, or a panel.

As discussed herein, the polymeric core layer may expand upon heating above a threshold temperature. Such an expansion preferably is greater than expansion due to the increased specific volume of a material as it is heated as liquid or solid and greater than an expansion due to a solid to liquid phase transition. For example, the expansion may result from a chemical reaction, and/or a phase transition from a solid or liquid to a gas phase. Preferred chemical reactions include reactions that produce a gas phase product from a solid or liquid phase reactant. Expansion of the core layer may be localized to one or more regions of the composite material or may be over the entirety of the composite material. For example, the expansion may result in one or more bulges in the composite material. A composite material that has metal layers that are initially parallel, may have metal layers that are no longer parallel in a region of a bulge. The percent expansion of the core layer may be defined by: E_{c}=100%×Δt/tᵢ, where Δt is the change in thickness of the core layer after expansion (e.g., at its thickest location and/or location that has expanded the most) and tᵢ is the initial thickness of the core layer. If the expansion of the core layer is too low, the composite material may not offer sufficient improvement in slowing the flow of thermal energy through the composite material. The percent expansion of the core layer, E_{c}, may be about 5 percent or more, about 10 percent or more, about 20 percent or more about 40 percent or more, about 60 percent or more, about 80 percent or more, or about 100 percent or more. If the percent expansion of the core layer is too high, convective heat flow may become a problem. The percent expansion of the core layer may be about 1000% percent or less, about 900 percent or less, about 800 percent or less, about 700 percent or less, about 600 percent or less, or about 500 percent or less.

Blowing Agent

Examples of blowing agents that may be employed include chemical blowing agent and hydrates. The chemical blowing agent may be any compound that reacts during the extreme thermal event to produce a gas at the elevated temperature. Examples of chemical blowing agents include azodicarbonamides and sodium bicarbonate. The gas may also be formed by the reaction of monomers, such as during a condensation reaction, whereby water, carbon dioxide or other low boiling point molecules are formed.

A hydrate including one or more waters of hydration. The water typically is bonded to a metal or a metal containing base compound. The compound may have hydrated water, coordinated water, or both. Examples of based compounds includes metal salts, metal halides, metal carbonates, alkaline metal sulfates, alkaline metal halides, alkaline metal carbonates, alkaline earth metal sulfates, alkaline earth metal halides, alkaline earth metal carbonates, or any combination thereof. Preferred alkali metals include K and Na. Preferred alkaline earth metals include Ca and Mg. Preferred halides include bromides and chlorides. The meal salt, metal halides, metal carbonates Preferred metals include Cr, Mn, Fe, Co, Ni, Cu, Cd, V, Al, Mg, or any combination thereof. The number of waters of hydration per molecule (or per metal atom) may be one or more, two or more, three or more, four or more, five or more, or six or more. Some or all of the waters of hydration may be released during an extreme thermal event. The number of waters of hydration released may be one or more, two or more, three or more, four or more, or five or more. A compound having two or more waters of hydration may release or generate water at different temperatures.

By way of example calcium chloride is a hygroscopic salt that can be anhydrous, or have 1, 2, 4 or 6 waters of hydration. The hexahydrate form will convert to the tetrahydrate form at about 30° C., giving off two waters of hydration. The tetrahydrate will convert to the dihydrate at a temperature of about 46° C., giving off two waters of hydration. The dihydrate will convert to the monohydrate at a temperature of about 175° C., giving off one water of hydration. The monohydrate will convert to the anhydrous compound at a temperature of about 260° C., giving off the last water of hydration. The hexahydrate and tetrahydrate compounds will generally give off water at the processing temperature of the polymer. This may be advantageous when producing a polymeric core layer that is foamed. Depending on the selection of the polymer, other waters of hydration may be given off during the processing of the polymer. However, it may be possible to prepare a polymeric core layer with the dihydrate (e.g., starting with the dihydrate, or starting with a tetrahydrate or hexahydrate and having some of the waters of hydration removed), provided that the layer is formed at a temperature less than 175° C. Similarly, a polymeric core layer may be formed with the monohydrate form, provided that the layer is formed at a temperature less than 260° C. If the polymeric core layer includes the dihydrate, one water of hydration will be released when the material reaches a temperature of about 175° C. and the last water of hydration will be released when the temperature increases to about 260° C.

The polymeric core layer may include a desiccant material having water. If employed, the desiccant preferably is provided with or charged with a predetermined amount of water. Although some of the water may be released during the formation of the polymeric core layer (such as discussed herein with respect to compounds having a water of hydration), it is preferred that some or all of the water is remaining in the desiccant after the polymeric core layer is formed. The water in the desiccant in the polymeric core layer may be released following a extreme thermal event as the polymeric core layer is heated. Examples of desiccants include molecular sieves, silica gel, anhydrocel (CaSO4), Anhydrone (Mg(ClO4)2), Ascarit, Desicchlora (Ba(ClO4)2), alumina (Al2O3), Mikohbite (68% NaOH, 32% fluffed mica), magnesium perchlorate, barium oxide, phosphorous pentoxide, lithium perchlorate, calcium chloride, sodium hydroxide, barium perchlorate, calcium oxide, magnesium oxide, and potassium hydroxide. Examples of molecular sieves includes zeolites.

In some cases, the release of water by a hydrate or by a desiccant will be an endothermic reaction. As such, the some of the thermal energy of the extreme thermal event will be consumed in generating the water. This can be useful in slowing the flow of heat through the thermal shielding device.

The polymeric core layer may be formed as a foamed core layer. Here, the thickness of the core layer increases with temperature (° K), such as a linear increase in volume according to ideal gas law. As the area of the thermal shielding device may be generally fixed, the expansion may be in the thickness direction, resulting in a thickness that increases generally linearly with temperature in ° K.

The polymeric core layer may include one or more flame retardants. The flame retardant may be a halogen containing flame retardant or may be a halogen free flame retardant. Any flame retardant that suppresses the combustion of the polymer in the core layer. Preferred flame retardants generated a gas (e.g., at a temperature above the critical temperature during an extreme thermal event) and/or have an endothermic reaction that consumes thermal energy. Examples of flame retardants include mineral flame retardants, organohalogen compounds, organophosphorus compounds, inorganic phosphate compounds, organic phosphate compounds, and graphene. Examples of minerals that may be employed as a flame retardant include aluminum hydroxide, magnesium hydroxide, huntite, hydromagnesite, red phosphorous, boron compounds, or any combination thereof. The boron compound may be a borate. Examples of organohalogen compounds include organochlorines and/or organobromines. Preferably, the organohalogen is used with a synergist, such as an antimony containing compound. Preferred synergists include antimony oxide, antimony pentoxide, and sodium antimonate. Examples of organophosphorus compounds include organophosphates, phosphonates, and phosphinates. The organophosphorus compound may include a halogen, preferably a chlorine or a bromine. Other organophosphorus compounds are halogen free. It may be desirable that the flame retardant is halogen free so that exposure to halogenated decomposition products is reduced or eliminated.

The flame retardant preferably prevents the polymer from burning for a period of time. For example, when one metal layer is exposed to a direct flame, the delay of burning of the polymer, may allow the other metal layer to remain at a temperature of 600° F. or less for 5 minutes or more, preferably for 7 minutes or more, and most preferably for 10 minutes or more.

The polymeric core layer may include a reinforcing filler. Preferred reinforcing fillers are mineral fillers. The polymeric layer may include metal fibers or metal particles. Metal fibers or metal particles in the polymeric core layer may increase the thermal conductivity of the core layer. Preferably the amount of metal fibers and metal particles in the polymeric core layer is sufficiently low so that the thermal conductivity of the layer is about 2.00 W/mK or less, preferably about 1.00 W/mK or less, and more preferably about 0.80 W/mK or less. Preferably the amount of metal in the polymeric core layer is about 10.0 volume percent or less, more preferably about 6.0 volume percent or less, even more preferably about 3.0 volume percent or less, and most preferably about 2.0 volume percent or less. The polymeric core layer may be entirely free or substantially free (for example 1.0 volume percent or less or 0.5 volume percent or less) of metal.

The composite material may be free of welds, bolts or other connectors that limit the ability of the core material to expand in regions for which thermal shielding is most desired. Bolts, welds, connectors preferably are located in regions away from shielding region. For example, connections through both metal layers may occur at a periphery region or edge region of the composite material. May occur at an extension region, where the composite material extends into a region away from a heat source. Bolts, welds, connectors in a shielding region may attach to only one of the metal layers, so that the distance between the metal layers is not constrained by the connector. As such, it may be possible for the core layer to expand, even though one of the metal layers is connected to another component.

One or meltable connectors may be used to connect the first metal layer and the second metal layer. The meltable connector may melt during an extreme thermal event so that first and second metal layers can separate from each other. A meltable connector may include or be formed of a polymer that melts at any of the temperatures described herein for the core layer. A meltable connector may include or be formed of a polymer described herein for the core layer.

Edge Sealing

The two or more metal layers may be sealed together, typically along one or more edges. Sealing of the edges may improve the ability of the composite material to expand and retain gas that is generated or released during an extreme thermal event. The two metal layers may be sealed by joining them together directly or indirectly. For example, the tow metal layers may be joined together using a third metal layer. As another example, one of the metal layers may have an extension region that is bent to reach or cover the other metal layer so that the two metal layers may be directly attached. As another example, there may be a region that is free of the polymeric core layer near the edge of the metal layer, so that the faces of the two metal layers in that region can be contacted together and joined.

It will be appreciated that an edge region may be located sufficiently far from heat generated from the extreme thermal event that the polymeric core layer functions as a seal in the edge region. As such, there may be no need to seal or join together the two metal layers in order to achieve expansion of the core layer, particularly where the expansion is localized to one or more regions (e.g., away from an edge).

FIG. 5 illustrates an example of a shielding device including metal outer layers and separated by a layer including one or more gas generating the material. The gas generating material may be a material that generates or releases gas upon being heated. The gas creates an outward pressure on the metal layers causing them to separate. In some cases, it may be necessary for one or more, or even all of the edges of the metal layers to be sealed together to reduce or prevent the escape of the gas. The separation of the metal layers may be local at one or more regions, or may be over essentially the entire area of the metal layer. It will be appreciated that edges that are sealed together may be difficult to expand. However, if both expansion and sealing at the edges are needed, the sealing of the edges can be achieved using one or more edge expansion components that allow the height of the seal (i.e., the distance between the two metal layers at the edge) to increase. For example, the seal may include one or more folds, pleats, grooves or other structure that can expand at low forces. For example, when the core layer is in a melt state (above its glass transition temperature and above its melting temperature) the expansion component of the edge seal may require a force of less than 25% of the yield stress of the metal layer in order for the height of the seal to increase. The edge expansion component may allow the height of the edge to increase by about 5% or more, about 15% or more, about 35% or more, about 70% or more, about 100% or more, about 175% or more, or about 250% or more.

Attachment of the thermal shielding device may employ any attachment component or method used for attaching metals and/or composite materials. Examples of attachments include welding, bolts, and rivets. The attachment may use one of the metal layers or both of the metal layers.

The thermal shielding device may be attached to a device capable of generating thermal energy. The thermal shielding device may be attached to an assembly, frame or panel so that it is positioned over a device capable of generating thermal energy.

In many applications the thermal shielding device will be attached or mounted to an assembly, frame or panel. When the thermal shielding device is mounted it may be difficult for the device to expand at the regions where it is attached. It may be possible to attach the thermal shielding device only at positions where expansion is not as important. For example, the thermal shielding device may be attached only at or near edge regions, at or near extension regions, at or near bent portions, or any combination thereof. The thermal shielding device may include one or more extension regions, such as illustrated in FIG. 2. The extension region may be a region where shielding is needed. The extension region may be used for attaching the thermal shielding device. When the extension region is used for attaching the thermal shielding device, it preferably is in a location where shielding is not needed or where reduced thermal shielding is needed.

The thermal shielding device includes one or more shielding regions 100 where the device helps to reduce the flow of thermal energy. The shielding region preferably includes or consists of a composite material according to the teachings herein. The thermal shielding device may include one or more extension regions 102. Although the thermal shielding device may also function to reduce the flow of thermal energy in the extension region(s), the requirement for thermal shielding in these regions typically is reduced. The extension region may be employed for attaching the thermal shielding device to an assembly, a panel, a frame, or other component. The extension region may include the same material (e.g., composite material) as the shielding region, or may be formed of a different material. As illustrated in FIG. 2, an extension region 102 may be used as an attachment location 104. An attachment location 104 may be located in an edge region 106 of the thermal shielding device, such as illustrated in FIG. 3. Preferably the edge region is about 150 mm or less, about 100 mm or less, about 50 mm or less, or about 25 mm or less from an edge of the heat shielding device. An extension region may include a bent portion or a protrusion angled relative to a shielding region. The bent portion or protrusion 108 may be generally perpendicular to the shielding region 100, such as illustrated in FIG. 4. The bent portion or protrusion 108 may be formed of the same material or of a different material as the shielding region 100. For example, a protrusion 108 may be formed of a generally monolithic material, such as illustrated in FIG. 4.

It may also be possible to attach the thermal shielding device using only one of the metal layers. Here, the attached layer is in a generally fixed position and the other layer may be able to move from the attached layer.

Gas in the polymeric core layer (e.g., before expansion and/or after expansion) and/or in the space between the metal layers preferably is substantially free of oxygen molecules (i.e., O₂). The amount of oxygen molecules in the polymeric core layer and/or in the space between the metal layers preferably is about 24 percent or less, more preferably about 18 percent or less, even more preferably about 10 percent or less, even more preferably about 5 percent or less, and most preferably about 1 percent or less, based on the total number of gas molecules in the polymeric core layer. The amount of oxygen molecules may be about 0 percent or more.

The separation of the metal layers may be by the action of a spring. For example, the device may include one or more springs in a non-equilibrium state (a compressed or elongated state). Preferably the spring is in a compressed state. The spring is prevented from returning to an equilibrium state by one or more components of the device. For example, the spring may be embedded in a polymer which is in a solid state. The polymer in a solid state may be a semi-crystalline polymer which is below its melting temperature and/or crystallization temperature. The polymer in a solid state may be a glassy polymer which is below its glass transition temperature. During its use, the polymer preferably remains in a solid state until it is exposed to a sufficiently high temperature that activates the expansion feature of the device. Here, the expansion feature may be activated by the melting or softening of the polymer. This may include heating the polymer to a temperature at or near its melting temperature (e.g., to a temperature of at least about Tₘ−10° C., about Tₘ, about Tₘ+30° C., about Tₘ+40° C., about Tₘ+50° C., about Tₘ+60° C., or about Tₘ+80° C.). The heating of the polymer allows the spring to return toward its equilibrium length and applies a force to separate the metallic layers.

During an extreme thermal event, the thermal shielding device may be exposed to heat, typically from a heat source 116 located on one side of the device. The heat causes gas generation in the core layer and/or gas expansion in the core layer. The core layer including the gas 110 applies a pressure 114 onto the metal layers. The metal layers may then separate from each other, typically with an increase in the thickness of the core layer 110. It will be appreciated that in addition to, or instead of the core layer expanding, a separate gas phase may form between the two metal layers. The two metal layers may be sealed together 112 to prevent gas from escaping at an edge, such as illustrated in FIG. 5.

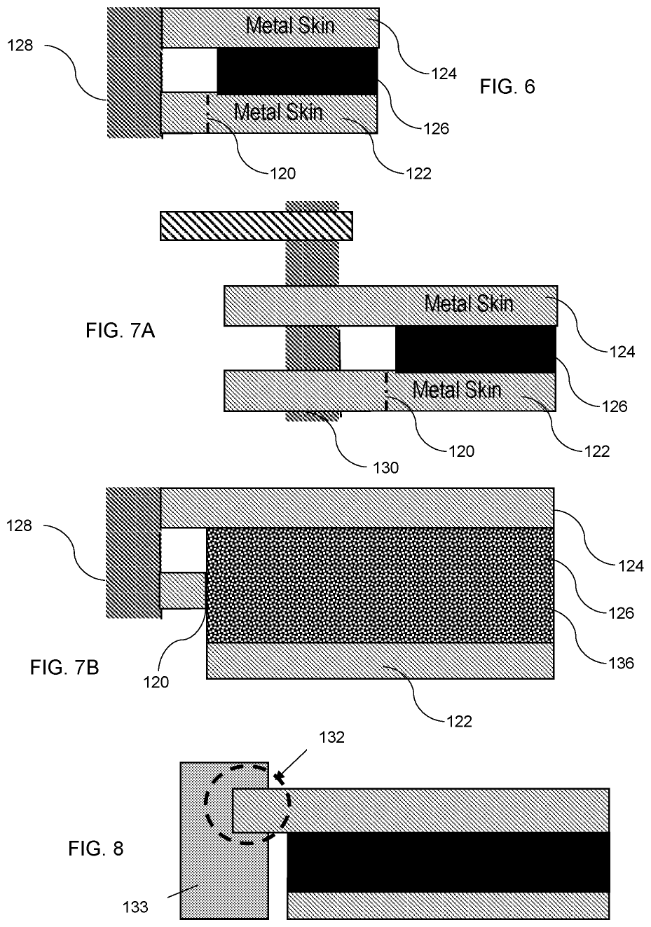

The thermal shielding device may include a break point, such as a perforation, scoring, thinned region, or other feature that results in one of the metal layers breaking at a predetermined location. The breaking of the metal layer may occur due to pressure generated in the core layer, such as during an extreme thermal event. It will be appreciated that the break point may include one or more points, may include one or more generally straight lines, or may include one or more generally curved lines. A break point may be used to aid in the separation of the metal layers. The break point preferably is at or near an edge region of the thermal shielding device. A break point may particularly be used when the edge region is sealed (e.g., when the two metal layers are welded or otherwise joined together). The thermal shielding device may have one metal layer that is a fixed layer and one metal layer that becomes movable after being broken, so that it can move away from the fixed metal layer. A thermal shielding device having a break point is illustrated in FIG. 6. With reference to FIG. 6, a metal layer 122 including a break point 120 may be attached to a fixed metal layer 124. The attachment may be via an edge region component 128. It will be appreciated that the edge region component is formed from one of the metal layers, or is formed from a different part. The thermal shielding device preferably includes a core layer 126 which preferably generates and/or releases gas upon being heated. The core layer 126 may extend to the edge region component 128 or there may be a gap in the edge region where there is no core layer material. For example, the core layer material may end before or at the break point, such as illustrated in FIG. 6. A break at the break point may occur due to the pressure of the gas in the core layer, such as during an extreme thermal event. Examples of breaking points include perforations, scoring, notched regions, and thinned regions.

FIGS. 7A and 7B illustrate a thermal shielding device attached at an edge region and including one or more features for breaking at a predetermined location. FIG. 7A shows the structure prior to breaking of the metal layer 122 and FIG. 7B shows the structure after the breaking of the metal layer 122, where this layer has moved away from a fixed metal layer 124. The thermal shielding device may be attached to another component using an attachment component 130. The attachment component may also attach both metal layers of the composite material together. After the core layer expands 136, the movable metal layer 122 may break at the breaking point and move away from the fixed metal layer 124, particularly in a shielding region. Although the core layer is shown ending before or near the break location, it may extend past the break location or even to the edge.

The thermal shielding device may be connected to an assembly, a panel, a frame, or other component 133 using a connector or attachment component 132, such as illustrated in FIG. 8. The connector or attachment component may be connected to both of the metal layers. Preferably, the connector or attachment component is connected to only one of the metal layers, so that there is a fixed (or connected metal layer) and a movable metal layer that moves after an extreme thermal event.

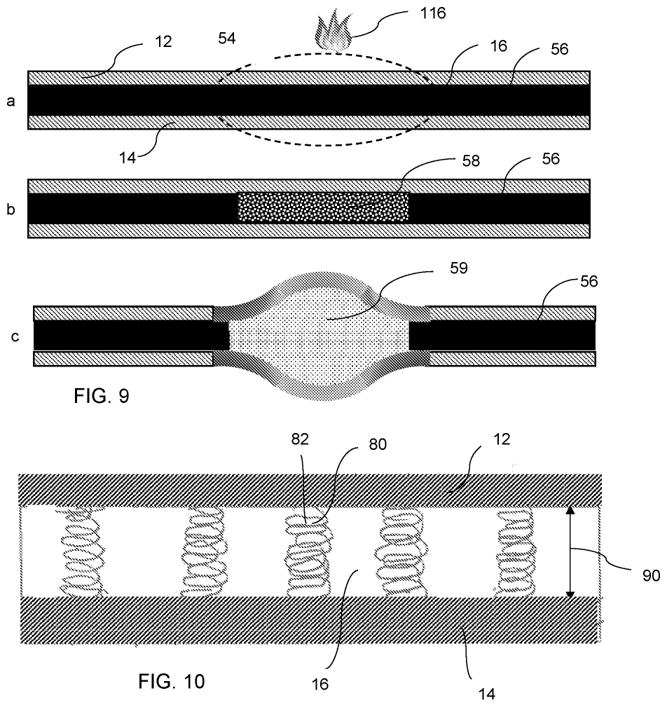

It will be appreciated that that an extreme thermal event may result in separation of the metal layers only in one or more regions, such as illustrated in FIG. 9. For example, the thermal energy may cause only local melting and/or only local generation or release of gas.

Heat 116 on one or both sides of the thermal shielding device may initially heat a first region 54 of the polymeric core layer.

Initially, the core layer includes a polymer in a solid state 56 (e.g., having crystallinity and/or below its glass transition temperature. As the polymer is heated it melts and/or softens and is in a liquid state 58, preferably above its glass transition temperature and without any crystalline phase. The melting and/or softening may be localized to a region being heated.

Gas may be released or generated in a heated region when the temperature reaches a critical point, or activation temperature. The gas may cause the core layer to expand 59 in the heated region 54. The expansion may be on one or both sides of the thermal shielding device. The expansion may be symmetrical. The heated region 54 may expand over time with additional heating. Because of the size of the thermal shielding device, there may be regions where the core layer is still in a solid state 56, even when the core has expanded (e.g., by 25% or more, 50% or more, 75% or more, or 100% or more) in the heated region 54. The expanded core layer 59 results in a separation of the metal layers 12, 14 at or near the heated region 54.

The thermal shielding device may include one or more components in the core layer 16 for storing potential energy 80. Upon heating (e.g., upon melting or softening) the polymer, the stored potential energy is released, causing the core layer to expand and a separation distance 90 between the metal layers 12, 14 to increase. The potential energy may be stored in one or more springs 82, such as illustrated in FIG. 10. The springs may be spaced apart, preferably throughout the area of the thermal shielding device. The springs preferably are arranged so that the thickness of the core layer and/or the spacing between the metal layers increases when the polymer melts or softens and the spring returns from a compressed state towards an uncompressed state.

One or more features may be used to cause the separation distance 90 between the metal layers to increase during an extreme thermal event.

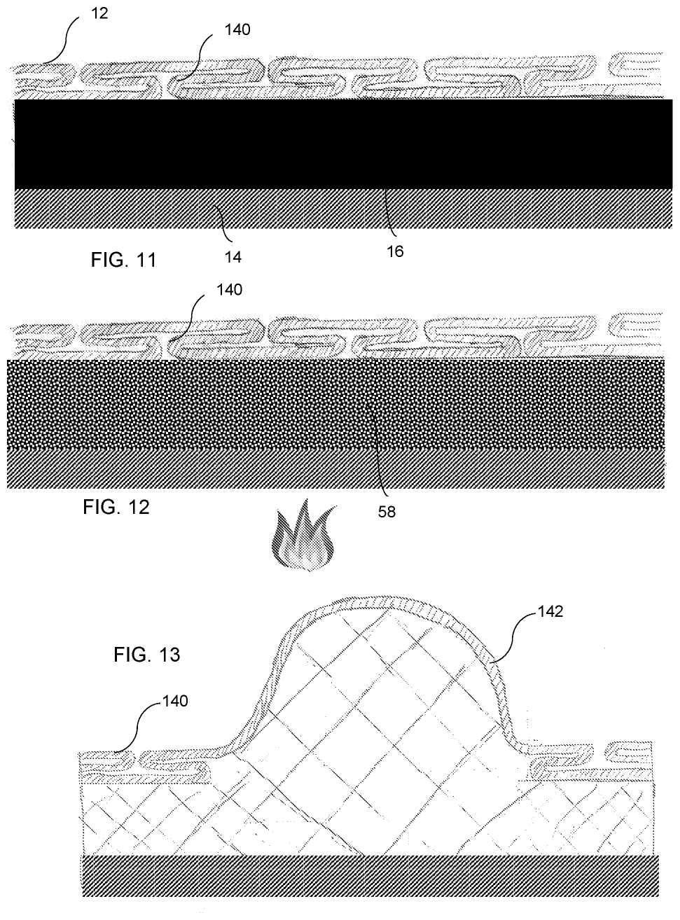

One or both of the metal layers 12, 14 may include one or more features that allows the layer to expand (e.g., in length, width, or area), preferably without yielding the metal material. For example, the metal layer may include one or more folds 140, creases, wrinkles or pleats, such as illustrated in FIG. 11.

Upon heating a region of the thermal shielding device, a portion of the polymer in the core layer may become molten and/or soften 58, such as illustrated in FIG. 12.

As the metal layers separate, a metal layer may expand 142 in area by removing some or all of the folds, wrinkles, creases or pleats, such as illustrated in FIG. 13. This allows the metal layers to separate in a region without the metal layer stretching and yielding.

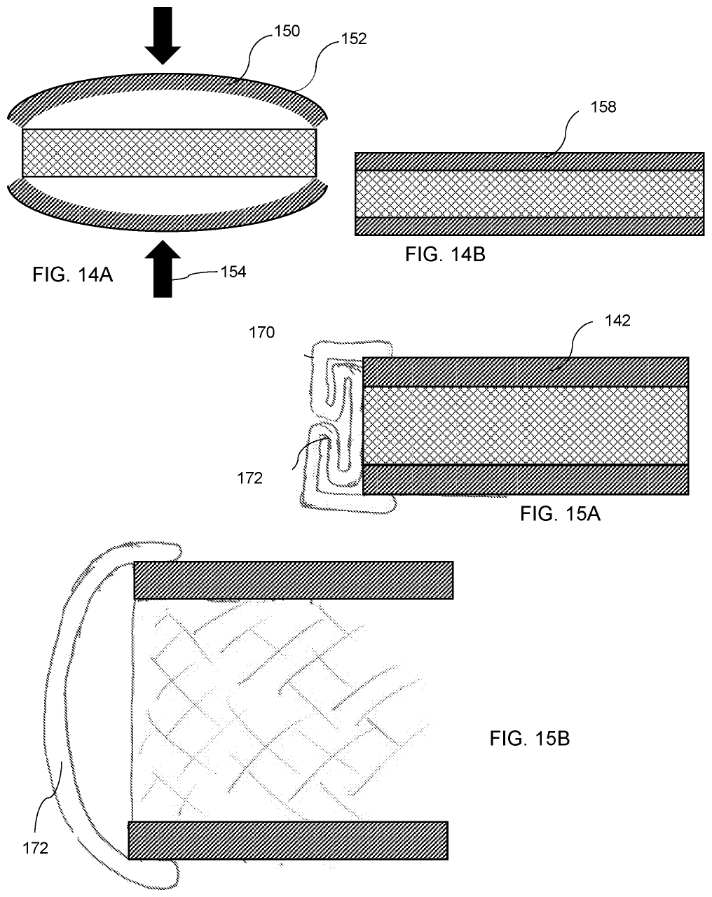

The thermal shielding device may have potential energy from a metal layer (or both metal layers) being in a compressed state 158. For example, one or more metal layers may have a curved configuration 150 prior to forming the thermal shielding device. During the forming of the device, the metal layer may be compressed 154 and is held in a compressed state, e.g., by the core layer. Upon melting or softening of the polymer in the core layer, the metal layer may return back towards its curved and/or uncompressed configuration. This may cause an increase in the thickness of the core layer and or an increase in a separation distance of the metal layers. FIG. 14A illustrates metal layers that are curved, prior to forming the thermal shielding device. FIG. 14B shows the thermal shielding device with the metal layers in a compressed state. The metal layers may be maintained in a flattened orientation by physical or mechanical means. For example, the metal layers may be adhered to the core layer. As another example, the layers may be attached via one or more connectors (e.g., in central regions of the thermal shield device). Connectors preferably are meltable connectors. It will be appreciated that the flattened orientation should be reversed upon heating, such as in an extreme thermal event. In the uncompressed state, such metal layer(s) preferably has an outer surface that is convex 152.

An edge of the thermal shielding device may be covered with an edge covering component 170. The edge covering component may be capable of expanding (preferably without yielding) when the thickness of the core layer increases and/or a separation distance of the metal layers increases. For example, the covering component may include one or more folds, wrinkles, pleats, or creases 172, such as shown in FIG. 15A. When the core layer expands 174, one or more of the folds, wrinkles, pleats, or creases may be at least partially removed so that the edge covering component can expand without yielding. Preferably, the edge covering component maintains contact with the metal layers and/or seals the edge prior to and during expansion of the core layer.

The thermal shielding device may also assist in providing EMI shielding to one or more components.

The thermal shielding device preferably has good sound dampening properties as characterized by a composite loss factor of about 0.010 or more at a temperature of about 50° C. and a frequency of about 100 Hz.

Battery and/or Electric Vehicle (i.e., EV)

The thermal shielding device according to the teachings herein may be employed in a system including a battery. The thermal shielding device may shield a compartment from the battery when an extreme thermal event occurs from the battery or affecting the battery. For example, the battery may be in an electric vehicle and the thermal shielding device may shield a compartment of an EV. The electric vehicle may be a hybrid EV or a plug-in EV. Preferably the battery provides power for an electric motor that drives the vehicle. The EV preferably is free of an internal combustion engine. The battery may include one or more battery cells for providing power.

The thermal shielding device may be used as a cover of a battery, a housing of a battery, or may be a separate component spaced apart from the battery. The thermal shielding device may shield any vehicle compartment from the battery. The compartment shielded by the thermal shielding device may include a storage area, a computer or other electronic controls, or a passenger area. Preferably the thermal shielding device shields a passenger compartment. The compartment may be above the battery, below the battery, in front of the battery, or behind the battery. As discussed herein, the thermal shielding device reduces heat flow through the device and thus may reduce heat flow into the shielded compartment. The battery cover may be arranged over or in front of one or more battery cells. The battery cover may be generally horizontal, angled, or generally vertical.

The thermal shielding device may be generally flat. The thermal shielding device may be formed from a flat sheet having a uniform thickness and/or a planar surface. For example, the thermal shielding device may be formed by pressing or stamping. The thermal shielding device may have one or more regions with a planar surface. The thermal shielding device may have a surface including regions (or entirely) having a shape that is similar to a housing of a battery. There may be a gap above, or below the battery cover (e.g., for a generally horizontal battery cover). There may be a gap in front of, or behind the battery cover (e.g., for a generally vertical battery cover). A gap may between the battery and the battery cover and/or between the battery cover and a passenger compartment.

The thermal shielding device may be attached to a frame of a vehicle or to a panel of a vehicle. The thermal shielding device may be attached to a container (e.g., a housing) that hold one or more battery cells. The thermal shielding device may be oriented so that it provides a barrier between a device that generates heat (e.g., during an extreme thermal event) and the compartment or area being shielded. The thermal shielding device may be sufficiently large so that it provides a substantial or complete barrier to the compartment or area being shielded.

What is claimed is:

1. A thermal shielding device comprising:
i. a first metal layer;
ii. a second metal layer;
iii. a polymeric core layer interposed between the first metal layer and the second metal layer, wherein the thermal shielding device has a thermal conductivity of about 0.05 to about 4 W/mK, and upon heating to a temperature of about 100° C. or more, the polymeric core layer causes a separation distance between the first and second metal layers to increase in one or more regions and a thickness of the thermal shielding device to increase by about 15 percent or more in the one or more regions.

2. The thermal shielding device of claim 1, wherein the polymeric core layer generates or releases a sufficient amount of gas at a temperature of about 100° C. or more to cause the separation of the metal layers and the increase in the thickness of the thermal shielding device in the one or more regions.

3. The thermal shielding device of claim 1 wherein the polymeric core layer is characterized by one or any combination of the following:
i) the polymeric core layer includes a compound having one or more waters of hydration; or
ii) the polymeric core layer is formed of a material, excluding any voids and/or pores in the polymeric core layer, having a density of about 0.90 to about 2.00 g/cm³ at a temperature of about 25° C.; or
iii) the polymeric core layer includes a polymer, and the thermal shielding device includes a catalyst that accelerates a degradation of the polymer so that the pressure between the metal layers is increased;
optionally wherein the thermal shielding device has a thickness of about 0.70 mm to about 5.0 mm, and wherein a ratio of a thickness of the polymeric core layer to the thickness of the thermal shielding device is about 0.25 to about 0.80;
optionally wherein the polymeric core layer melts and expands at a temperature of about 100° C. or more;
preferably wherein the melting and expansion of the polymeric core layer increases a separation distance between the first and second metal layers.

4. (canceled)

5. (canceled)

6. The thermal shielding device of claim 1, wherein the polymeric core layer includes a gas generating or releasing compound (e.g., a chemical blowing agent, a hydrate, a desiccant material, a flame retardant, or other compound) that preferably activates at a temperature of about Tm+30° C. or more, where Tm is a peak melting temperature of the polymeric core layer, as measured according to differential scanning calorimetry.

7. The thermal shielding device of claim 1, wherein the polymeric core layer includes a flame retardant compound;
preferably wherein the flame retardant compound is characterized by one or any combination of the following:
i) the flame retardant compound includes a halogenated compound (preferably including bromine); or
ii) the flame retardant compound includes a compound that produces or releases water a temperature of about Tm+30° C. or more, where Tm is a peak melting temperature of the polymeric core layer, as measured according to differential scanning calorimetry; or
iii) the flame retardant compound includes phosphorous or graphene.

8. The thermal shielding device of claim 1, wherein the polymeric core layer includes a reinforcing filler (preferably a mineral filler).

9. (canceled)

10. The thermal shielding device of claim 1, wherein an amount of metal fibers or other metal particles in the polymeric core layer is sufficiently low so that the thermal conductivity of the polymeric core layer is about 2.0 W/mK or less;
preferably wherein the metal particles includes metal fibers;
preferably thermal conductivity of the polymeric core layer is about 1.00 W/mK or less, and more preferably about 0.80 W/mK;
preferably wherein the amount of the metal particles is about 10.0 volume percent or less, based on the volume of the polymeric core layer.

11. The thermal shielding device of claim 1, wherein the device provides EMI shielding properties.

12. The thermal shielding device of claim 1, wherein the polymeric core layer is characterized by one or any combination of the following:
i) the polymeric core layer includes a first polymer having a melting temperature of about 100° C. to about 225° C.; or
ii) the polymeric core layer providing an increased separation between the first and second metal layers upon melting of the first polymer; or
iii) the polymeric core layer includes multiple layers including a mid layer interposed between two additional layers,
iv) the mid layer comprises the first polymer, and the two additional layers include one or more second polymers that are cross-linked and/or have a melting temperature greater than the melting temperature of the first polymer; or
iv) a melting of the polymeric core layer initially occurs towards a center of the polymeric core layer.

13. (canceled)

14. The thermal shielding device of claim 1, wherein the device includes a sealing component for covering an edge of the polymeric core layer;
optionally wherein the sealing component is characterized by one or any combination of the following:
i) a sealing component is attached to only one of the metal layers; or
ii) a sealing component is attached only to the first metal layer; or
iii) a sealing component is attached only to the second metal layer; or
iv) a sealing component is formed by bending the first metal layer or the second metal layer; or
v) a sealing component is formed by bending the first metal layer over an edge of the second metal layer.

15. The thermal shielding device of claim 14, wherein the sealing component is welded to the second metal layer;
preferably wherein at least a portion of the sealing component is interposed between the first metal layer and the second metal layer.

16. The thermal shielding device of claim 15, wherein
i) the core polymeric layer extends to the sealing component and/or
ii) a void space is present between the edge of the core polymeric layer and the sealing component.

17. (canceled)

18. The thermal shielding device of claim 1, wherein the first metal layer includes a first metal sheet having a length and a width and the second metal layer includes a second metal sheet having a length and/or a width that is different from the first metal sheet.

19. The thermal shielding device of claim 1, wherein the battery cover has good sound dampening properties as characterized by a composite loss factor of about 0.010 or more at a temperature of about 50° C. and a frequency of about 100 Hz.

20. The thermal shielding device of claim 1, wherein the thermal shielding device is characterized by one or any combination of the following:
i) the thermal shielding device, in an initial state prior to heating, includes a mechanical or physical feature; preferably wherein stored with potential energy that is released upon melting and/or softening of the polymer in the one or more regions; or
ii) the thermal shielding device includes one or more springs that store potential energy, wherein the spring(s) is in a compressed state and arranged for expanding in a direction of the thickness of the thermal shielding device; or
iii) the thermal shielding device includes one or more metal layers being in a compressed state that store potential energy, wherein the metal layer moves towards the uncompressed state upon melting and/or softening of the polymer, causing the metal layers to separate; or
iv) the thermal shielding device includes an oriented polymer and/or a compressed rubber in the core layer that stores potential energy.

21. The thermal shielding device of claim 1, wherein one or both of the metal layers includes a wrinkle, a fold, a pleat, or other feature that allows the metal layer to expand, preferably without yielding.

22. The thermal shielding device of claim 1, wherein one or more edges of the device is covered with a folded covering component which covers the edges and unfolds when the metal layers separate; optionally wherein the covering component seals the metal edge of the thermal shielding device; optionally wherein the folded covering component is formed from one of the metal layers and/or is connected to the metal layers.

23. A battery cover for a plug-in electric vehicle comprising a thermal shielding device of claim 1,
wherein the polymeric core layer has a thermal conductivity of about 0.05 to about 4 W/mK, and the battery cover is positioned between a vehicle battery that provides power for an electric motor that drives the vehicle and a passenger compartment;
wherein the battery cover has a thickness of about 0.7 mm to about 5 mm, and a ratio of a thickness of the polymeric core layer to the thickness of the battery cover is about 0.25 to about 0.80.

24. A system comprising
the battery cover of claim 23,
an electric motor for driving one or more wheels of a vehicle;
one or more battery cells for providing power to the electric motor;
wherein the battery cover is arranged over one or more of the battery cells,
preferably wherein the battery cover is generally horizontal;
optionally wherein the battery cover is attached to a container that holds one or more battery cells and/or the battery cover is attached to a vehicle body and arranged below a passenger compartment;
optionally wherein the system includes a gap above or below the battery cover for allowing a separation of the first and second metal layers to increase.

25. A thermal shielding device comprising:
i. a first metal layer;
ii. a second metal layer;
iii. a polymeric core layer interposed between the first metal layer and the second metal layer, wherein the thermal shielding device has a thermal conductivity of about 0.05 to about 4 W/mK, and upon heating to a temperature of about 100° C. or more, the polymeric core layer causes a separation distance between the first and second metal layers to increase in one or more regions and a thickness of the thermal shielding device to increase by about 15 percent or more in the one or more regions;
wherein the polymeric core layer includes a gas generating or releasing compound that generates or releases a gas upon heating the thermal shielding device to an activation temperature,
wherein the gas generating or releasing compound is selected from the group consisting of a chemical blowing agent, a hydrate, and a desiccant material.
